(19) United States
(12) Patent Application Publication
(10) Pub. No.: US 2018/0056808 A1
(43) Pub. Date: Mar. 1, 2018

(54) ENERGY MANAGEMENT SYSTEM

(71) Applicant: Ten-D Energies, Inc., Mercer, WA (US)

(72) Inventors: Jerry Gibson, Mercer Island, WA (US); Mike Ma, Mercer Island, WA (US)

(21) Appl. No.: 15/610,502

(22) Filed: May 31, 2017

Related U.S. Application Data
(60) Provisional application No. 62/380,789, filed on Aug. 29, 2016.

(51) Int. Cl. B60L 11/18; H02J 7/00

(52) U.S. Cl. CPC B60L 11/1866; H02J 7/345; H02J 7/0021; H02J 7/0019

(57) ABSTRACT

A battery management system including sheets, a buffer circuit, and a master management system. The sheets each include energy storage devices and an active balancing circuit configured to use power received from a portion of the devices to charge a lowest voltage one of the devices. The master management system uses information received from the active balancing circuit of each of the sheets to identify a second portion of the sheets and instructs the buffer circuit to receive first power from a first portion of the sheets, and send at least a portion of the first power to the second portion of the sheets. The battery management system may be included in an electric vehicle. Each of the sheets may include a communication hardware module that sends a parameter to the master management system, which the master management system may send in a data package to an external computing system.

### CROSS REFERENCE TO RELATED APPLICATION(S)

This application claims the benefit of U.S. Provisional Application No. 62/380,789, filed on Aug. 29, 2016, which is incorporated herein by reference in its entirety.

### BACKGROUND OF THE INVENTION

### Field of the Invention

The present invention is directed generally to battery management systems of electric vehicles and the integration of cloud technologies with such battery management systems.

### Description of the Related Art

An electric vehicle (“EV”) includes a battery management system (“BMS”) connected to a high voltage battery pack. The BMS regulates the battery pack and helps maximize its efficiency. The battery pack consists of dozens of individual batteries and/or capacitors (each referred to as a cell) stacked in series (referred to as a stack). While the EV's power system treats the battery pack as a single, high-voltage battery—charging and discharging the entire battery pack at once—the BMS must independently consider the condition of each cell to ensure the cell's continued functioning. In general, a typical BMS provides the following ten functions:
1. Data acquisition;
2. Guaranteeing safety;
3. Determining and predicting the state of the battery;
4. Controlling charging and discharging of the battery;
5. Cell balancing;
6. Thermal management;
7. Delivery of battery status and authentication to a user interface;
8. Communication with all battery components;
9. Prolonging battery life; and
10. Communication to the EV drive controllers.

Unfortunately, lithium-ion battery packs (of the type currently used in EVs) are vulnerable to a variety of factors (such as fluctuations in temperature), which can negatively impact longevity and/or performance of the cells. A poorly regulated environment and/or differences in production tolerances create problems in an EV's battery system that increase over time. For example, if one particular (weaker) cell in a stack has slightly less capacity than the other cells in the stack (which is a common occurrence), a state of charge of the particular cell will diverge from the state of charge of the rest of the cells over multiple charge/discharge cycles. The state of charge is similar to a fuel level in gas combustion engines. The magnitude of this divergence (or disparity in capacity) increases as the number of charge/discharge cycles increases. Thus, the state of charge of the particular (weaker) cell must be periodically balanced with the state of charge of the rest of the cells in the stack to counteract the existing disparity in capacity. If this is not done, the particular (weaker) cell will eventually be driven into deep discharge, leading to severe degradation of the cell and eventually a complete failure of the stack. Thus, if the weaker cell dies, it can cause the entire stack to fail prematurely, even though the other cells are still viable. Cell balancing corrects this problem by equalizing the charge on all of the cells in the stack, which extends the life of the battery pack.

Cell balancing is one of the most critical functions of the BMS. Balancing the states of charge of the cells requires monitoring the voltage of each cell to determine its state of charge. In addition, the BMS must be capable of individually charging or discharging the cells to balance their states of charge.

Cell balancing can be passive or active. Passive balancing (also referred to as dissipative balancing) draws (excess) energy from the cells having the greatest charge in the battery pack and dissipates that (excess) energy in the form of heat, typically through resistors. Thus, the states of charge of the cells are balanced by dissipating excess energy until the voltage of the strongest cells matches the voltage of the weakest cells.

On the other hand, active balancing (also referred to as non-dissipative balancing) transfers energy between the cells. Prior art active balancing methods vary based on the type of energy transfer. For example, the energy transfer can occur from a single cell to the entire stack (or the entire battery pack), from the entire stack (or the entire battery pack) to a single cell, or from cell to cell. The energy transfer can also be bidirectional.

In active balancing, energy is first transferred from a strongest cell to the entire stack (or the entire battery pack) or to one or more other cells. Then, the energy is transferred from the entire stack (or the entire battery pack) or the other cells to the weakest cell in the stack (or the battery pack). The advantage of active balancing over passive balancing is that active balancing does not dissipate (or waste) energy, which improves efficiency of the EV's power system. The disadvantage of active balancing is that active balancing requires more components than passive balancing, which means active balancing costs more to implement and requires more space than passive balancing.

A more recent development in the EV industry is the incorporation of cloud technologies, which incorporate EVs into the Internet of Things (“IoT”). There have been numerous innovations that aim to use cloud technologies to improve the efficiency of EV usage overall. Connecting EVs to the cloud allows for large scale data collection and makes it possible to coordinate the actions of EV owners to reach the optimal outcome for all involved parties. For instance, a number of companies use networked EV charging stations, and some sell cloud-based services that allow charging station owners to manage charging and billing. The cloud can also be used to connect an EV driver to the nearest charging station and deliver on-demand support and billing services. Cloud computing can be used to transmit messages directly to and from EVs. One increasingly common of the cloud is to send messages asking that an EV's owner briefly stop charging. Such messages help with grid stability because electrical grids are subject to local blackouts when they are overloaded. This risk is particularly high during peak usage times.

Cloud technology may also be used to provide vehicle owners with access to EV data and software anytime and anywhere. It is no longer necessary to purchase and install costly software because software may be remotely delivered through the cloud. This drastically reduces the costs to EV owners, particularly for software that requires frequent updates.

EVs are connected to the cloud through on-board wireless modules integrated into the vehicle's BMS. Such modules allow the vehicle to communicate with the cloud via a standard cellular connection. Unfortunately, this method of communication carries with it increasing costs as the amount of data collected and sent via the cellular connection increases. A less costly option is to have the vehicle's system connect to any open Wi-Fi network that is within range at the time and beam data to the cloud when this opportunity presents itself. With the number of Wi-Fi hotspots continuously on the rise, this is a viable solution for many EV owners who prefer not to pay for unlimited data plans.

### BRIEF DESCRIPTION OF THE SEVERAL VIEWS OF THE DRAWING(S)

FIG. 1 is a block diagram of an electric vehicle with a battery management system (“BMS”) that includes a Battery and/or Capacitor Management System (“B/CMS”) configured to communicate with a cloud computing system.

FIG. 2 is a block diagram of a sheet of the BMS of FIG. 1 and a Battery and/or Capacitor Management Board (“B/CMB”), the sheet including an active balancing and communication circuit and one or more bricks.

FIG. 3A is a block diagram of one of the bricks that includes cells connected together in parallel.

FIG. 3B is a block diagram of the bricks of the sheet in FIG. 2 connected together in series.

FIG. 4 is a circuit diagram illustrating an isolated direct current to direct current (“DC-DC”) converter assembly of the active balancing and communication circuit.

FIG. 5 is a circuit diagram illustrating an isolated multiplexer circuit of the active balancing and communication circuit.

FIG. 6 is a flow diagram of a method performed by a microprocessor of the active balancing and communication circuit.

FIG. 7A is a block diagram of a first embodiment of a smart bi-directional energy buffer circuit.

FIG. 7B is a block diagram of a second embodiment of the smart bi-directional energy buffer circuit.

FIG. 7C is a block diagram of a third embodiment of the smart bi-directional energy buffer circuit.

FIG. 8 is a block diagram of an exemplary implementation of the cloud computing system of FIG. 1 including one or more computing devices.

FIG. 9 is a diagram of a hardware environment and an operating environment in which the computing device(s) of the cloud computing system of FIG. 1 may be implemented.

Like reference numerals have been used in the figures to identify like components.

### DETAILED DESCRIPTION OF THE INVENTION

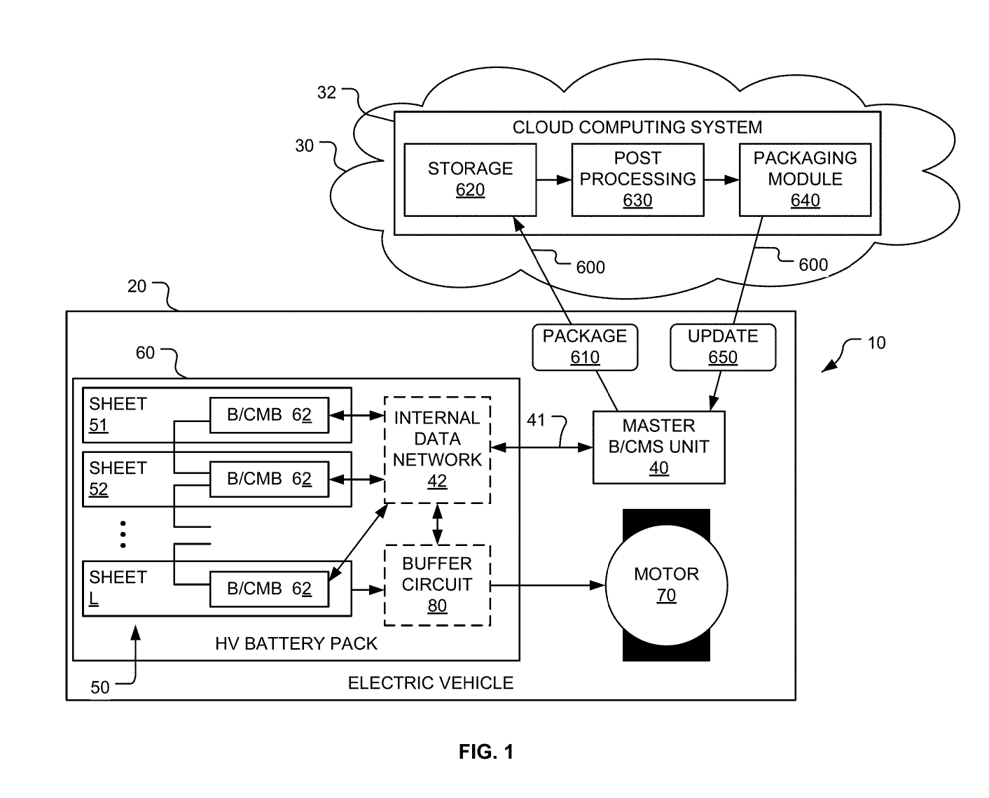

FIG. 1 is a block diagram illustrating components of a battery management system (“BMS”) 10 of an electric vehicle (“EV”) 20. The BMS 10 may be connected to a network 30, which includes or is connected to a cloud computing system 32 (e.g., located in one or more remote datacenters). The cloud computing system 32 executes cloud-linked software (e.g., stored in modules 630 and 640) that is demand-allocated and not tied to a physical location. The BMS 10 uses software (e.g., the cloud-linked software) to manage power output and address power mismatch issues, which differs significantly from current industry practices that primarily use hardware and/or only locally executing software. The BMS 10 may be configured to provide improved power management and/or safety. By providing cloud-linked software solutions for common hardware problems, the BMS 10 helps reduce consumer costs, a need for continuous hardware changes and/or updates, and potential hazards involved in using the EV 20. The cloud-linked software solutions may include algorithms based on (or utilizing) big data analysis. Further, in addition to performing the ten functions (listed above) of a typical BMS, the BMS 10 may provide one or more of the following three innovations:
1. Second-generation active balancing (classified as “hyper-balancing”) provided by smart bi-directional active buffering;
2. Cloud connectivity and active intervening; and
3. Redundancy.

The BMS 10 includes a Master Battery and/or Capacitor Management System (“B/CMS”) unit 40 connected via a (wireless and/or wired) connection 41 to a (wireless or wired) internal data network 42 of a high voltage battery pack 60. The battery pack 60 includes one or more sheets 50 connected together in series or parallel. In the embodiment illustrated, the sheet(s) 50 include sheets 51-L connected together in parallel. The value “L” represents a maximum number of sheet(s) in the battery pack 60. A different Battery and/or Capacitor Management Board (“B/CMB”) 62 is connected to (e.g., plugged into) each of the sheet(s) 50. Inside the battery pack 60, the internal data network 42 is connected to the B/CMB 62 of each of the sheet(s) 50.

The battery pack 60 is connected to and powers an electric motor 70 of the EV 20. Optionally, the battery pack 60 may include a buffer circuit 80 connected between the sheet(s) 50 and the electric motor 70. The Master B/CMS unit 40 is connected to the buffer circuit 80 by the internal data network 42. The Master B/CMS unit 40 may monitor and/or control the buffer circuit 80.

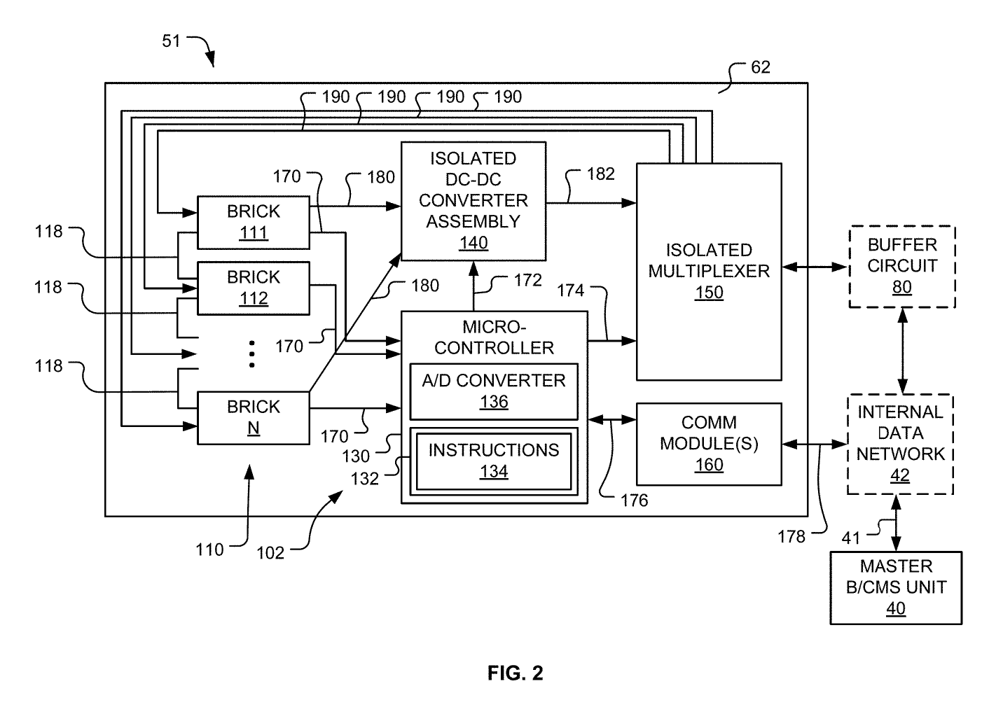

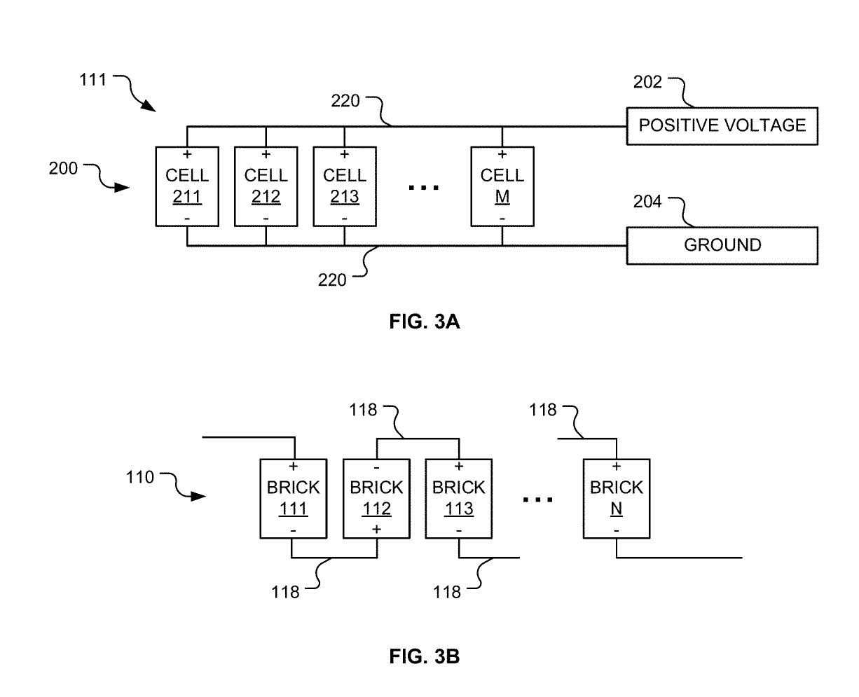

FIG. 2 illustrates an exemplary one of the sheet(s) 50 (e.g., the sheet 51) connected to the B/CMB 62. The B/CMB 62 includes an active balancing and communication circuit 102 connected to one or more energy storage devices or bricks 110. In the embodiment illustrated, the brick(s) 110 include bricks 111-N. Referring to FIG. 3B, the bricks 111-N are connected together (e.g., by wires 118) in series. Alternatively, the bricks 111-N may connected together in parallel (not shown). Returning to FIG. 2, the value “N” represents a maximum number of bricks in the sheet 51. The maximum number (“N”) of bricks in the sheet 51 is governed by a maximum voltage allowed within the sheet 51. For example, if each of the bricks 111-N has a maximum voltage of 4.2 Volts (“V”), the bricks 111-N are connected together in series, and the maximum voltage allowed within the sheet 51 is 38 V, the maximum number (“N”) is nine (38/4.2≈9.05). This means the sheet 51 may include at most nine bricks, because including any additional bricks would exceed the maximum voltage allowed within the sheet 51. The characteristics of the bricks 111-N are generally homogenous, meaning the bricks 111-N have substantially identical chemical compositions, maximum/minimum voltages, environmental temperature responses, and the like. Additionally, the bricks 111-N have substantially identical energy capacities.

Referring to FIG. 3A, each of the bricks 111-N (e.g., the brick 111) includes one or more individual cells 200 connected to a positive terminal 202 and a negative (ground) terminal 204. In the embodiment illustrated, the brick(s) 110 (see FIGS. 2 and 3B) each include cells 211-M connected together in parallel (e.g., by wires 220). Alternatively, the cells 211-M of each of the brick(s) 110 may be connected together in series (not shown). Thus, a brick may be defined as a set of the cells 211-M connected together in either series or parallel. The value

“M” represents a maximum number of cells in the brick 111. The maximum number (“M”) of cells in the brick 111 is independent of the voltage of the brick 111. Therefore, the maximum number (“M”) of cells is selectable by an entity constructing the sheet 51. Each of the cells 211-M may be implemented as a capacitor, a battery (e.g., LiFePO₄ type battery), another type of industry-standard battery, and the like. The characteristics of the cells 211-M within each of the bricks 111-N (see FIGS. 2 and 3B) are generally homogeneous, meaning the cells 211-M have substantially identical chemical compositions, maximum/minimum voltages, environmental temperature responses, and the like.

Referring to FIG. 2, the active balancing and communication circuit 102 includes a processor or microcontroller 130, an isolated direct current to direct current (“DC-DC”) converter assembly 140, an isolated multiplexer 150, and one or more communication modules 160. The microcontroller 130 is connected to each of the bricks 111-N (e.g., by wire(s) 170). By way of non-limiting examples, the microcontroller 130 may be implemented as a conventional microprocessor, application specific integrated circuit (“ASIC”), digital signal processor (“DSP”), programmable gate array (“PGA”), and the like. While in the embodiment illustrated, the active balancing and communication circuit 102 includes the single microcontroller 130, in alternate embodiments, the active balancing and communication circuit 102 may include multiple processors and/or microcontrollers. For example, the active balancing and communication circuit 102 may include one microcontroller that is responsible for active balancing and a second microcontroller that is responsible for communication.

The microcontroller 130 contains and/or is connected to memory 132. The memory 132 may store instructions 134 and data to control operation of the microcontroller 130. By way of non-limiting examples, the memory 132 may include random access memory, ready-only memory, programmable memory, flash memory, and the like. Thus, the memory 132 may be implemented as one or more non-transitory computer or processor readable media storing the instructions 134. The active balancing and communication circuit 102 is not limited by any specific form of hardware used to implement the memory 132. The various components of the microcontroller 130 may be coupled together by a bus system (not shown). The bus system (not shown) may include an address bus, data bus, power bus, control bus, and the like.

The microcontroller 130 (e.g., its bus system) may be connected to the isolated DC-DC converter assembly 140 by wire(s) 172 and to the isolated multiplexer 150 by wire(s) 174. The microcontroller 130 may be connected to the communication module(s) 160 by a (wireless and/or wired) connection 176. The communication module(s) 160 is implemented as least in part by hardware. The communication module(s) 160 are connected to the internal data network 42 by a (wireless and/or wired) connection 178. As mentioned above, the Master B/CMS unit 40 is connected to the internal data network 42. Thus, the microcontroller 130 may communicate with the Master B/CMS unit 40 via the internal data network 42.

The microcontroller 130 receives an individual voltage signal from each of the bricks 111-N (e.g., via the wire(s) 170) that the microcontroller 130 uses to determine a brick voltage for each of the bricks 111-N. The microcontroller 130 may include or be connected to an analog-to-digital converter 136. Thus, the microcontroller 130 may use the analog-to-digital converter 136 to convert one or more of the voltage signals received from the bricks 111-N from an analog voltage signal into a digital signal that may be processed by the microcontroller 130 and/or sent to the communication module(s) 160 (e.g., via the connection 176).

After the microcontroller 130 has determined the brick voltage for each of the bricks 111-N, the microcontroller 130 executes the instructions 134, which instruct the microcontroller 130 when to turn on the isolated DC-DC converter assembly 140. The isolated DC-DC converter assembly 140 receives power from the bricks 111-N via wires 180 and supplies at least a portion of the received power to the isolated multiplexer 150 via wires 182.

The microcontroller 130 controls the isolated multiplexer 150, which is connected to the bricks 111-N by wires 190. The instructions 134 instruct the microcontroller 130 when to select one or more of the bricks 111-N and electrically connect the selected brick(s) to the isolated multiplexer 150, which sends power to and charges the selected brick(s).

The microcontroller 130 may send data to the Master B/CMS unit 40 through the communication module(s) 160 and the internal data network 42. The communication module(s) 160 may be configured to communicate with the Master B/CMS unit 40 (via the internal data network 42) wirelessly and/or via a wired connection. The microcontroller 130 may receive data and commands from the Master B/CMS unit 40 via the communication module(s) 160 and the internal data network 42. The communication module(s) 160 may be configured to use any suitable network protocol and associated network backend, such as CAN, RS-485, IEEE 802.11, Bluetooth Smart, IEEE 802.15.4, or other similar standards and/or proprietary methods.

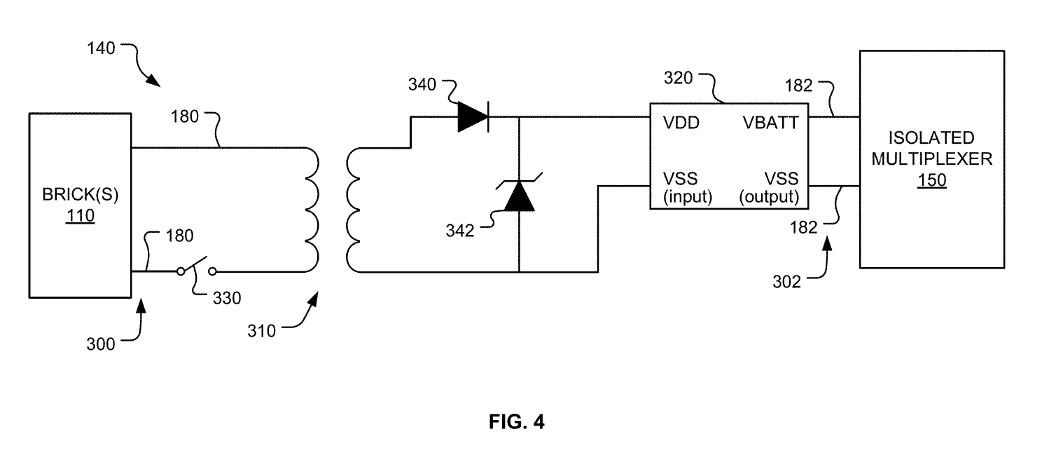

Referring to FIG. 4, as mentioned above, the isolated DC-DC converter assembly 140 is connected to the brick(s) 110 by the wires 180. Energy flows through the isolated DC-DC converter assembly 140 in a single direction from an input end 300 (connected to the brick(s) 110) to an output end 302 (connected to the isolated multiplexer 150).

The isolated DC-DC converter assembly 140 includes charger logic and/or components. In the embodiment illustrated, the isolated DC-DC converter assembly 140 has a charger circuit topology that includes a DC-DC converter portion 310 connected to a charger logic module 320 (e.g., implemented as an integrated circuit). The DC-DC converter portion 310 is an electronic module (e.g., one or more transformers) that receives a full voltage direct current (“DC”) signal from the brick(s) 110 (via the wires 180), generates an alternating current (“AC”) signal from the full voltage DC signal, reduces the voltage of the AC signal, and converts the reduced voltage AC signal into a reduced voltage DC signal having a lower voltage. For example, if the maximum voltage for the sheet 51 (see FIG. 2) is 38 Volts, the isolated DC-DC converter assembly 140 may drop the voltage (38 V) of the full voltage DC signal to the lower voltage (e.g., approximately 5 V).

Then, the reduced voltage DC signal may enter the charger logic module 320. The charger logic module 320 has two input terminals and two output terminals. A first (positive) input terminal “VDD” is connected to the DC-DC converter portion 310 and receives the reduced voltage DC signal. A second (negative) input terminal “VSS (input)” is connected to ground. A first (positive) output terminal “VBATT” is connected (as an input) to the isolated multiplexer 150 and the second (negative) output terminal “VSS (output)” is connected to ground. Thus, the output of the charger logic module 320 is sent to the isolated multiplexer 150, which uses the output to charge the bricks 111-N (see FIGS. 2 and 3B) one at a time.

In the embodiment illustrate, the isolated DC-DC converter assembly 140 includes or is connected to a switch 330. A combination of the switch 330 opening and closing at certain frequencies and the DC-DC converter portion 310 (e.g., one or more transformers) generates the AC signal from the full voltage DC signal received from the brick(s) 110. An AC component of the AC signal passes through the DC-DC converter portion 310 (whereas a DC signal would not), and produces the reduced voltage AC signal. Then, the isolated DC-DC converter assembly 140 (e.g., diodes 340 and 342) converts the reduced voltage AC signal to the reduced voltage DC signal. When the switch 330 is open, the isolated DC-DC converter assembly 140 is disabled.

The microcontroller 130 may send a switching signal to the isolated DC-DC converter assembly 140 to turn the isolated DC-DC converter assembly 140 on and off. The isolated DC-DC converter assembly 140 may buffer this switching signal and decide (based on the buffered signal) whether to open or close the switch 330. Optionally, the isolated DC-DC converter assembly 140 may include a switch (not shown) that is opened and closed based on the buffered signal. Referring to FIG. 2, as mentioned above, the instructions 134 instruct the microcontroller 130 when to turn on the isolated DC-DC converter assembly 140 and which of the bricks 111-N, if any, to charge using the charger logic module 320 (see FIG. 4) and the isolated multiplexer 150. The charger logic module 320 may be implemented as a Lithium Ion (“Li-Ion”) charger logic module. It should be noted that the charger logic module 320 is not limited to charging Li-Ion type batteries. By way of non-limiting examples, the charger logic module 320 may be used to charge capacitors and LiFePO₄ type batteries, as well as a variety of other industry-standard batteries and capacitors.

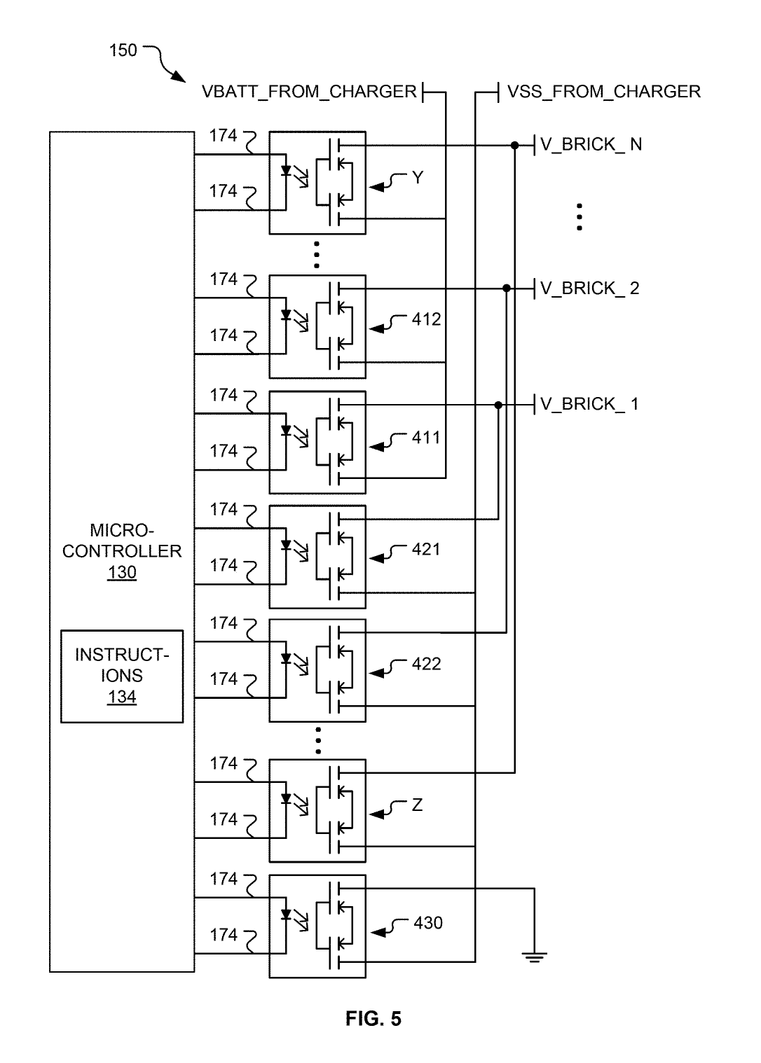

FIG. 5 illustrates exemplary topology that may be used to implement the isolated multiplexer 150. The isolated multiplexer 150 has a first (positive) input terminal “VBATT_FROM_CHARGER,” a second (negative) input terminal “VSS_FROM_CHARGER,” and output terminals “V_BRICK_1” to “V_BRICK_N.” The first (positive) input terminal “VBATT_FROM_CHARGER” is connected (by one of the wires 182 illustrated in FIGS. 2 and 4) to the first (positive) output terminal “VBATT” (see FIG. 4) of the charger logic module 320 (see FIG. 4). The second (negative) input terminal “VSS_FROM_CHARGER” is connected (by a different one of the wires 182 illustrated in FIGS. 2 and 4) to the second (negative) output terminal “VSS” (see FIG. 4) of the charger logic module 320 (see FIG. 4). The output terminals “V_BRICK_1” to “V_BRICK_N” are connected (by the wires 190 illustrated in FIG. 2) to the bricks 111-N (see FIGS. 2 and 3B), respectively, of the sheet 51 (see FIG. 2).

The isolated multiplexer 150 includes a set of first relays 411-Y that are connected to the output terminals “V_BRICK_1” to “V_BRICK_N,” respectively. Each of the first relays 411-Y are also connected to the first (positive) input terminal “VBATT_FROM_CHARGER.” The first relays 411-Y may each be implemented as a solid-state relay. The instructions 134 instruct the microcontroller 130 as to which of the first relays 411-Y to turn on. In this manner, the instructions 134 determine which of the bricks 111-N (see FIGS. 2 and 3B) is connected to the first (positive) input terminal “VBATT_FROM_CHARGER.”

The isolated multiplexer 150 includes a set of second relays 421-Z and 430. The second relays 421-Z are connected to the output terminals “V_BRICK_1” to “V_BRICK_N,” respectively. The second relay 430 is connect to ground. The second relays 421-Z and 430 are also connected to the second (negative) input terminal “VSS_FROM_CHARGER.” The second relays 421-Z and 430 may each be implemented as a solid-state relay. Immediately after one of the first relays 411-Y (e.g., the first relay 411) is turned on, one of the second relays 421-Z and 430 is turned on in such a way that none of the output terminals “V_BRICK_1” to “V_BRICK_N” shorts, reverses voltage, and/or is connected to a voltage greater than its input voltage.

The wire(s) 174 connect the microcontroller 130 with each of the first and second relays 411-Y, 421-Z, and 430. Thus, the microcontroller 130 may toggle any combination of the first and second relays 411-Y, 421-Z, and 430 on or off. However, hardware and/or the instructions 134 (e.g., software code) governing the microcontroller 130 allow only one of the bricks 111-N (see FIGS. 2 and 3B) to be connected to the first (positive) output terminal “VBATT” (see FIG. 4) of the charger logic module 320 (see FIG. 4) at a time (e.g., without swapping the positive and negative terminals). For example, the microcontroller 130 may turn on the first relay 411 (connecting the first (positive) input terminal “VBATT_FROM_CHARGER” to the output terminal “V_BRICK_1”), turn off the first relays 412-Y, turn off the second relays 421-Z (connecting to the second (negative) input terminal “VSS_FROM_CHARGER” to the output terminals “V_BRICK_1” to “V_BRICK_N”), and turn on the second relay 430 (connecting to the second (negative) input terminal “VSS_FROM_CHARGER” to ground), which will cause the reduced voltage signal (received from the charger logic module 320 illustrated in FIG. 4 via the first (positive) input terminal “VBATT_FROM_CHARGER”) to flow to only the brick 111 (connected to the output terminal “V_BRICK_1”).

Similarly, if the output terminal “V_BRICK_2” has the lowest voltage (as measured between the output terminals “V_BRICK_2” and “V_BRICK_1”), the microcontroller 130 will first turn off all of the first and second relays 411-Y, 421-Z, and 430. Then, the microcontroller 130 will turn on the first relay 412 and the second relay 421 (while the other relays 411, Y, 422-Z, and 430 remain turned off). In this example, the brick voltages are measured between one of the output terminals “V_BRICK_1” to “V_BRICK_N” and an immediately adjacent output terminal. For example, the brick voltage of the brick N (see FIGS. 2 and 3B) may be measured between the output terminals “V_BRICK_N” and “V_BRICK_N-1.” Similarly, the brick voltage of the brick 112 (see FIGS. 2 and 3B) may be measured between the output terminals “V_BRICK_2” to “V_BRICK_1,” and so forth. An output terminal “V_BRICK_0” (not illustrated) is ground. Thus, the brick voltage of the brick 111 (see FIGS. 2 and 3B) may be measured between the output terminals “V_BRICK_1” and “V_BRICK_0.”

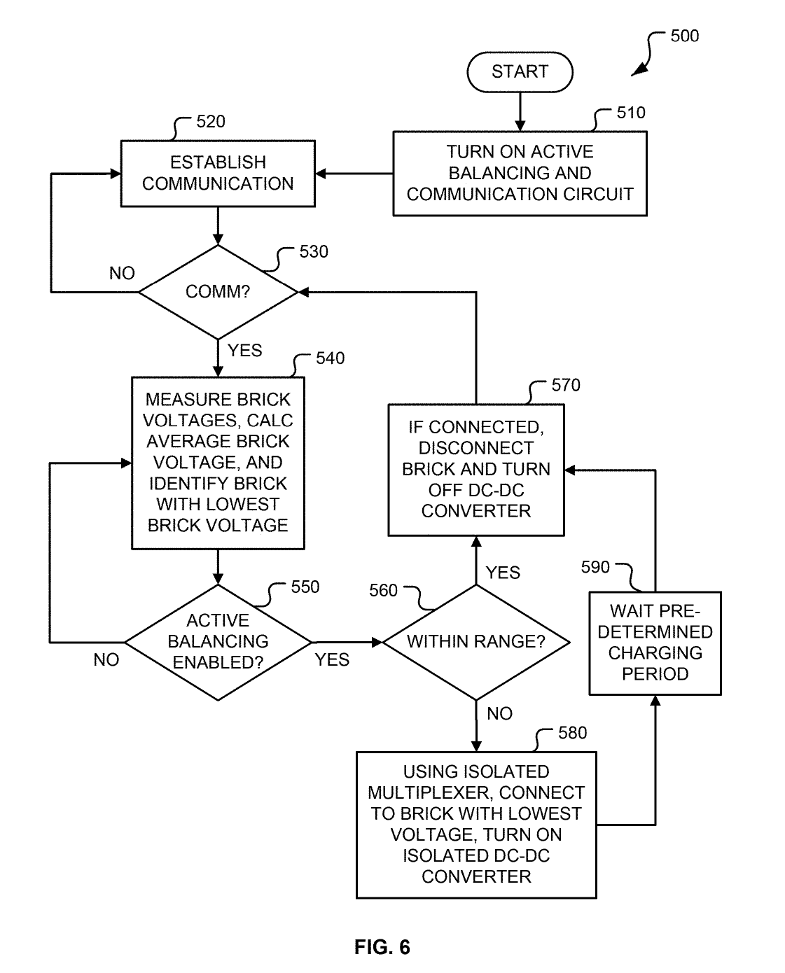

FIG. 6 is a flow diagram of a method 500 of implementing active balancing as well as connecting and transferring data between the Master B/CMS unit 40 (see FIGS. 1, 2, and 7A-7C) and the cloud computing system 32 (see FIG. 1). The method 500 may be performed separately for each of the sheet(s) 50 (see FIG. 1). For example, multiple instances of the method 500 may be performed simultaneously or in parallel for two or more of the sheet(s) 50 (see FIG. 1). For ease of illustration, the method 500 will be described as being performed with respect to the sheet 51 (see FIG. 2).

Referring to FIG. 2, in first block 510 (see FIG. 6), the active balancing and communication circuit 102 of the B/CMB 62 is turned on. The active balancing and communication circuit 102 may be turned on in one of two ways. One, an operator may plug the B/CMB 62 into a fully charged sheet (e.g., the sheet 51 illustrated in FIGS. 1 and 2), which powers the active balancing and communication circuit 102 allowing it to turn on. Two, the bricks 111-N of the sheet 51 into which the B/CMB 62 is plugged-in may be charged externally (e.g., by a low voltage source, for example having a voltage below 5 V) until their combined voltage reaches a defined threshold that will allow the active balancing and communication circuit 102 to turn on. The second method is most likely to occur when at least some of the cells 211-M (see FIG. 3A) of the bricks 111-N are implemented as capacitors.

Next, in block 520 (see FIG. 6), the microcontroller 130 attempts to establish communication with the Master B/CMS unit 40 by sending and receiving data (e.g., handshake) via the communication module(s) 160 (over the connections 176 and 178).

In decision block 530 (see FIG. 6), the microcontroller 130 determines whether communication with the Master B/CMS unit 40 has been established. Referring to FIG. 6, if no communication is established (i.e., the decision in decision block 530 is “NO”), the microcontroller 130 (see FIGS. 2 and 5) remains in a low power state and returns to block 520 to attempt communication again.

On the other hand, if communication is established (i.e., the decision in decision block 530 is “YES”), in block 540, the microcontroller 130 (see FIGS. 2 and 5) monitors voltages and performs calculations. For example, referring to FIG. 2, in block 540 (see FIG. 6), the microcontroller 130 determines a brick voltage for each of the bricks 111-N, identifies one of the bricks 111-N as having the lowest brick voltage, and determines an average brick voltage for the bricks 111-N. As mentioned above, referring to FIG. 5, the brick voltages may be measured between one of the output terminals “V_BRICK_1” to “V_BRICK_N” and an immediately adjacent output terminal. For example, the brick voltage for the brick 112 may be measured between the output terminals “V_BRICK_2” and “V_BRICK_1”.

Then, the microcontroller 130 advances to decision block 550 (see FIG. 6) to determine whether active balancing is enabled. Active balancing may be enabled by a flag “fmr” governed by the Master B/CMS unit 40. Thus, the microcontroller 130 may receive the value of the flag “fmr” from the Master B/CMS unit 40. Referring to FIG. 6, if the flag “fmr” indicates that active balancing is enabled (i.e., the decision in decision block 550 is “YES”), the microcontroller 130 (see FIGS. 2 and 5) advances to decision block 560. On the other hand, if the flag “fmr” indicates that active balancing is disabled (i.e., the decision in decision block 550 is “NO”), the microcontroller 130 (see FIGS. 2 and 5) returns to block 540. By way of a non-limiting example, the Master B/CMS unit 40 may disable active balancing when the average brick voltage is sufficiently low (e.g., below a predetermined threshold value), the sheet and/or other components are overheating (e.g., because of a poorly maintained cooling system on a very hot day), the brick voltages are balanced (meaning there is no need to keep power elements running if they are simply monitoring voltages), one of the cells 211-M (see FIG. 3A) is over-voltage (i.e., a fault has occurred), and/or the sheet is operating in service mode (meaning there is no need to run active balancing).

In decision block 560, the microcontroller 130 (see FIGS. 2 and 5) decides whether the lowest brick voltage is within a predetermined range of the average brick voltage (calculated in block 540). For example, in decision block 560, the microcontroller 130 (see FIGS. 2 and 5) may determine whether a difference between the average brick voltage and lowest brick voltage is larger than a specified threshold value. When the lowest brick voltage is within the predetermined range of the average brick voltage, the decision in decision block 560 is “YES.” Otherwise, the decision in decision block 560 is “NO.”

When the decision in decision block 560 is “YES,” the brick with the lowest brick voltage does not need charging. Thus, in block 590, the microcontroller 130 (see FIGS. 2 and 5) turns off the isolated DC-DC converter assembly 140 (see FIGS. 2 and 4). Referring to FIG. 5, if the brick with the lowest brick voltage is connected to the isolated multiplexer 150, the microcontroller 130 disconnects the brick with the lowest brick voltage from the isolated multiplexer 150 by turning off one of the first relays 411-Y connected to the brick with the lowest brick voltage. For example, if the brick 111 (see FIGS. 2 and 3B) has the lowest brick voltage, the microcontroller 130 may turn off the first relay 411, which is connected to the brick 111 by the output terminal “V_BRICK_1.” The microcontroller 130 may also turn off the first relays 412-Y. Additionally, the microcontroller 130 may turn off the second relays 421-Z, which connect all of the bricks 111-N to the second (negative) input terminal “VSS_FROM_CHARGER” and turn off the second relay 430 (which is connected to ground). Then, the microcontroller 130 returns to decision block 530 (see FIG. 6).

When the decision in decision block 560 is “NO,” the brick with the lowest brick voltage needs charging. Thus, in block 580, the microcontroller 130 connects to the brick with the lowest brick voltage to the isolated multiplexer 150 and turns on the isolated DC-DC converter assembly 140 to begin charging the brick with the lowest brick voltage. Referring to FIG. 5, the microcontroller 130 connects the brick with the lowest brick voltage to the isolated multiplexer 150 by turning on one of the first relays 411-Y connected to the brick with the lowest brick voltage. For example, if the brick 111 (see FIGS. 2 and 3B) has the lowest brick voltage, the microcontroller 130 may turn on the first relay 411, which is connected to the brick 111 by the output terminal “V_BRICK_1.” The microcontroller 130 also turns on the second relay 430 connected to ground. The other first relays 412-Y and the second relays 421-Z remain off or are turned off by the microcontroller 130. By way of another non-limiting example, if the brick 112 (see FIGS. 2 and 3B) has the lowest brick voltage, the microcontroller 130 may turn on the first relay 412 and the second relay 421 (while the other relays 411, Y, 422-Z, and 430 remain turned off or are turned off by the microcontroller 130).

Then, referring to FIG. 2, in block 590 (see FIG. 6), charging continues for a predetermined charging period (e.g., a number of seconds) the duration of which is governed by the Master B/CMS unit 40. Thus, the Master B/CMS unit 40 may instruct the microcontroller 130 as to when the predetermined charging period has ended. Once the microcontroller 130 determines the predetermined charging period has elapsed, in block 570 (see FIG. 6), the microcontroller 130 turns off the isolated DC-DC converter assembly 140, and disconnects the isolated multiplexer 150 from the brick that had the lowest brick voltage before being charged. Then, the microcontroller 130 returns to decision block 530 (see FIG. 6). Using the active balancing and communication circuit 102 of the B/CMB 62 to safely charge the bricks 111-N (see FIGS. 2 and 3B) may involve additional safety considerations (such as over-voltage, under-voltage, over-temperature detection, and the like) that are not illustrated in the flow diagram of FIG. 6, and may be tailored to the specific cell types utilized to construct the bricks 111-N.

FIG. 1 illustrates one or more connections 600 (e.g., a wireless internet connection) between the Master B/CMS unit 40 and the cloud computing system 32. As mentioned above, the battery pack 60 includes the sheet(s) 50, which each includes the bricks 111-N (see FIGS. 2 and 3B). The bricks 111-N (see FIGS. 2 and 3B) each includes the cells 211-M (see FIG. 3A) that may be implemented as batteries and/or capacitors. Referring to FIG. 2, each of the sheet(s) 50 (see FIG. 1) is connected to the B/CMB 62, which is physically connected (via the wires 170, 180, and 190) to the bricks 111-N of the sheet.

Returning to FIG. 1, the B/CMB 62 of each of the sheet(s) 50 is connected to the single Master B/CMS unit 40 by the internal data network 42. The Master B/CMS unit 40 receives data from the B/CMB 62 of each of the sheet(s) 50 and transmits the data as a data package 610 over the connection(s) 600 to the cloud computing system 32. The data may include some or all of the information determined for each of the sheet(s) 50 in block 540 (see FIG. 6) of the method 500 (see FIG. 6). For example, the data may include, for each of the sheet(s) 50, the brick voltage of each of the bricks 111-N, an identifier of the bricks with the lowest brick voltage, and the average brick voltage for the bricks 111-N. By way of another non-limiting example, the data may include statistics such as an amount of current drawn from the bricks 111-N, an amount of current used, and the like.

The cloud computing system 32 stores the data package 610 in a data storage 620 that is part of the cloud computing system 32 and/or connected thereto. Then, the cloud computing system 32 executes instructions (stored in the post processing module 630) that perform post processing on the data stored in the data storage 620 to calculate certain energy-related performance parameters. These parameters may include charging time, current and/or wattage, brick voltage threshold, sheet voltage threshold, voltage delta to conclude being in balance, and the like. The instructions of the post processing module 630 may analyze at least a portion of the data stored in the data storage 620 for one or more electric vehicles (e.g., like the EV 20) to thereby obtain values based on big data analysis. For example, by analyzing information obtained from many electric vehicles, the cloud computing system 32 may better predict aging characteristics of the brick(s) 110 (see FIGS. 2 and 3B) and/or cell(s) 200 (see FIG. 3A).

The instructions of the post processing module 630 may generate feedback to apply to the Master B/CMS unit 40 and/or the B/CMB 62 of one or more of the sheet(s) 50. If feedback is generated, instructions (stored in the packaging module 640) package the feedback as a software update 650 and send the software update 650 to the Master B/CMS unit 40, which may distribute the software update 650 (via the internal data network 42) to the B/CMB 62 of one or more of the sheet(s) 50. The microcontroller 130 may receive the software update 650 (via the communication module(s) 160) and use the software update 650 to update or modify the instructions 134. The software update 650 may include one or more new instructions and/or new parameters (and/or modifications to one or more existing instructions and/or parameters). For example, if the operator decides to subscribe to (or unsubscribe from) a service (provided by the cloud computing system 32) that allows the operator to get more range from the battery pack 60, the software update 650 may change one or more parameters stored in the Master B/CMS unit 40 accordingly.

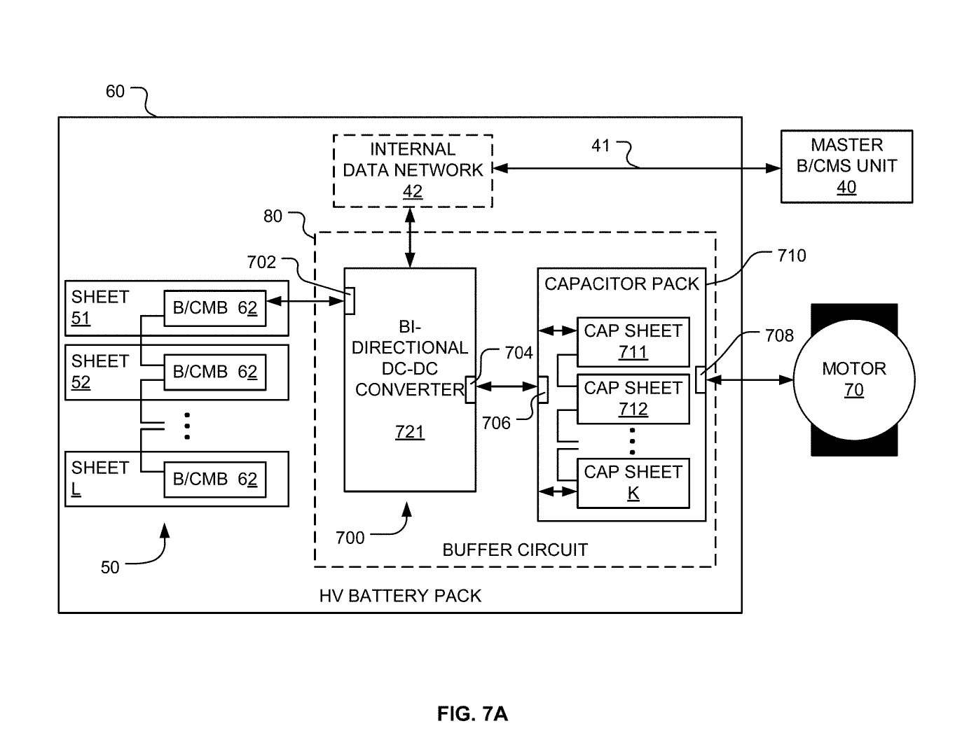

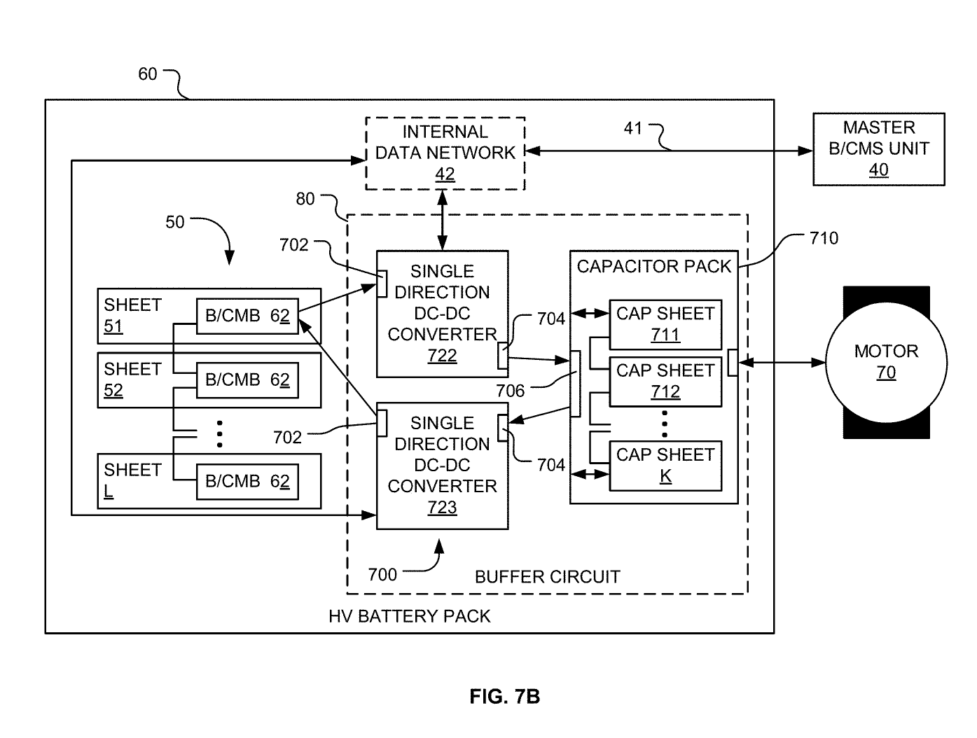

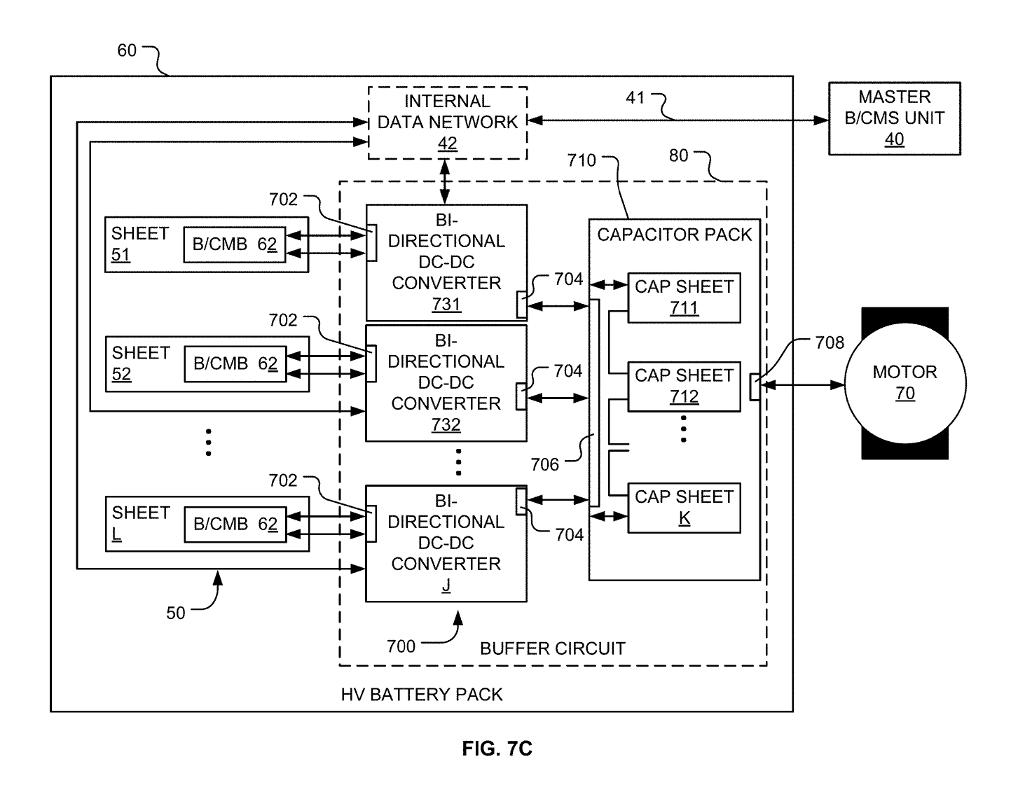

FIGS. 7A-7C are block diagrams illustrating exemplary configurations of the buffer circuit 80, which is connected to the sheet(s) 50 and receives power therefrom. In the embodiments illustrated in FIGS. 7A and 7B, the buffer circuit 80 allows a selected one of the sheet(s) 50 (e.g., the sheet having the lowest voltage or a sheet having a voltage below a predetermined threshold value) to be charged with energy from others of the sheet(s) 50. In the embodiments illustrated in FIGS. 7A-7C, the buffer circuit 80 implements a smart bi-directional energy buffer that includes one or more DC-DC converters 700 connected to a capacitor pack 710. The buffer circuit 80 may be configured to provide a high power density, increase the number of rechargeable cycles, and reduce charging/discharging times.

Each of the DC-DC converter(s) 700 may be implemented as either a bi-directional DC-DC converter or a single-direction DC-DC converter. Further, Each of the DC-DC converter(s) 700 may be implemented as a high power DC-DC converter. When power is flowing in a first direction from the sheet(s) 50 to the capacitor pack 710, the DC-DC converter(s) 700 increase(s) the voltage received from the sheet(s) 50 or maintain(s) the same voltage received from the sheet(s) 50. On the other hand, when power is flowing in a second direction from the capacitor pack 710 to the sheet(s) 50, the DC-DC converter(s) 700 decrease(s) the voltage of power sent to the sheet(s) 50 or maintain(s) the same voltage of the power sent to the sheet(s) 50.

When power is flowing in the first direction, the capacitor pack 710 receives and stores power from the DC-DC converter(s) 700. On the other hand, when power is flowing in the second direction, the capacitor pack 710 sends the stored (or buffered) power to the selected one of the DC-DC converter(s) 700, which forwards the power on to a selected one of the sheet(s) 50. The capacitor pack 710 may be configured to buffer power received from a large electrical load (e.g., the electric motor 70 of the EV 20 illustrated in FIG. 1) and send the buffered power to the selected one of the DC-DC converter(s) 700, which forwards the power on to the selected one of the sheet(s) 50.

Each of the DC-DC converter(s) 700 has a first terminal 702 and a second terminal 704. The first terminal 702 is connected to the sheet(s) 50 and the second terminal 704 is connected to the capacitor pack 710. Each of the DC-DC converter(s) 700 may produce a positive energy flow (in the first direction) or a negative energy flow (in the second direction) between the sheet(s) 50 and the capacitor pack 710 having a maximum rate (e.g., at least 10 Kilowatts).

The logic in the Master B/CMS unit 40 monitors and controls each of the DC-DC converter(s) 700. For example, the Master B/CMS unit 40 determines whether power flows through the DC-DC converter(s) 700 in the first direction or the second direction. The Master B/CMS unit 40 may determine to which of the sheet(s) 50 the power flows when the power is flowing in the first direction. In other words, the Master B/CMS unit 40 may identify the selected DC-DC converter and/or the selected sheet. Thus, the Master B/CMS unit 40 may be characterized as being the smart portion of the smart bi-directional energy buffer.

The capacitor pack 710 includes one or more capacitor sheets 711-K connected together in series. Each of the capacitor sheet(s) 711-K includes a set of capacitor cells. The capacitor pack 710 has one or more first terminals 706 and a second terminal 708. The first terminal(s) 706 of the capacitor pack 710 may be connected to the DC-DC converter(s) 700. The second terminal 708 of the capacitor pack 710 may be connected to the large electrical load (e.g., the electric motor 70 of the EV 20 illustrated in FIG. 1).

Referring to FIG. 7A, in this embodiment, the DC-DC converter(s) 700 include only a single bi-directional DC-DC converter 721. Each of the sheet(s) 50 is connected to the first terminal 702 of the bi-directional DC-DC converter 721. The second terminal 704 of the bi-directional DC-DC converter 721 is connected to the first terminal 706 of the capacitor pack 710.

The Master B/CMS unit 40 is connected to the bi-directional DC-DC converter 721 by the internal data network 42. As discussed above, referring to FIG. 1, the Master B/CMS unit 40 may receive the data from the B/CMB 62 of each of the sheet(s) 50. That data may include some or all of the information determined for each of the sheet(s) 50 in block 540 (see FIG. 6) of the method 500 (see FIG. 6). Thus, the Master B/CMS unit 40 may receive and/or calculate the voltage of each of the sheet(s) 50. Using this information, the Master B/CMS unit 40 selects one of the sheet(s) 50 that requires charging and instructs the bi-directional DC-DC converter 721 to receive power from capacitor pack 710 and send the received power to the selected sheet. The Master B/CMS unit 40 may also use this information to select one or more of the sheet(s) 50 from which to receive power and instruct the bi-directional DC-DC converter 721 to receive power from the selected sheet(s) and send the received power to the capacitor pack 710.

Referring to FIG. 7B, in this embodiment, the DC-DC converter(s) 700 include single-direction DC-DC converters 722 and 723, instead and in place of the bi-directional DC-DC converter 721 (see FIG. 7A). Each of the sheet(s) 50 is connected to the first terminal 702 of each of the single-direction DC-DC converters 722 and 723. The second terminals 704 of the single-direction DC-DC converters 722 and 723 are connected to the first terminal(s) 706 of the capacitor pack 710. Power flows in the first direction (from the sheet(s) 50 to the capacitor pack 710) through the single-direction DC-DC converter 722. Power flows in the second direction (from the capacitor pack 710 to the sheet(s) 50) through the single-direction DC-DC converter 723.

The Master B/CMS unit 40 is connected to each of the single-direction DC-DC converters 722 and 723 by the internal data network 42. As explained above, the Master B/CMS unit 40 selects one of the sheet(s) 50 that requires charging. Then, the Master B/CMS unit 40 instructs the single-direction DC-DC converter 723 to receive power from capacitor pack 710 and send the received power to the selected sheet. As also explained above, the Master B/CMS unit 40 may select one or more of the sheet(s) 50 from which to receive power. Then, the Master B/CMS unit 40 may instruct the single-direction DC-DC converter 722 to receive power from the selected sheet(s) and send the received power to the capacitor pack 710.

Referring to FIG. 7C, in this embodiment, the DC-DC converter(s) 700 includes a plurality of bi-directional DC-DC converter(s) 731-J each connected to the Master B/CMS unit 40 by the internal data network 42 (see FIGS. 1, 2, and 7A-7C). Each of the sheet(s) 50 is connected to the first terminal 702 of a different one of the bi-directional DC-DC converters 731-J. Optionally, one or more subsets of the sheet(s) 50 may be connected together in series. Any such subset(s) may be connected to one of the bi-directional DC-DC converters 731-J. The second terminal 704 of each of the bi-directional DC-DC converters 731-J is connected to the first terminal(s) 706 of the capacitor pack 710.

The Master B/CMS unit 40 determines which of the bi-directional DC-DC converter(s) 731-J sends power to the sheet(s) 50 when power is flowing in the second direction. Thus, the Master B/CMS unit 40 may charge only specific ones of the sheet(s) 50. As explained above, the Master B/CMS unit 40 selects one of the sheet(s) 50 that requires charging. Then, the Master B/CMS unit 40 turns on the bi-directional DC-DC converter connected to the selected sheet and instruct the buffer circuit 80 to allow the power to flow in the second direction to thereby charge the selected sheet (e.g., the sheet having the lowest sheet voltage). As also explained above, the Master B/CMS unit 40 may select one or more of the sheet(s) 50 from which to receive power. Then, the Master B/CMS unit 40 turns on those of the bi-directional DC-DC converter(s) 731-J connected to the selected sheet(s), and instructs the buffer circuit 80 to allow the power to flow in the first direction. Thus, the Master B/CMS unit 40 may discharge only specific ones of the sheet(s) 50.

In alternate embodiments (not shown), each of the bi-directional DC-DC converter(s) 731-J may be replaced with a pair of single-direction DC-DC converters (e.g., like the single-direction DC-DC converters 722 and 723).

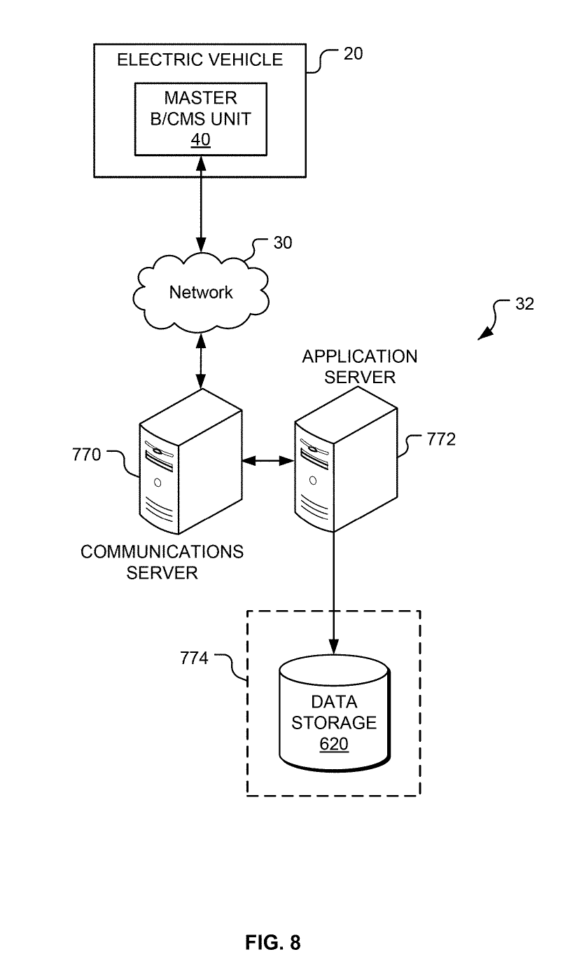

Referring to FIG. 8, as mentioned above, the Master B/CMS unit 40 is connected to the cloud computing system 32 (e.g., via the network 30). FIG. 8 illustrates aspects of an example implementation of the cloud computing system 32. As mentioned above, the Master B/CMS unit 40 is operable to send and/or receive requests, messages, and/or information via the network 30.

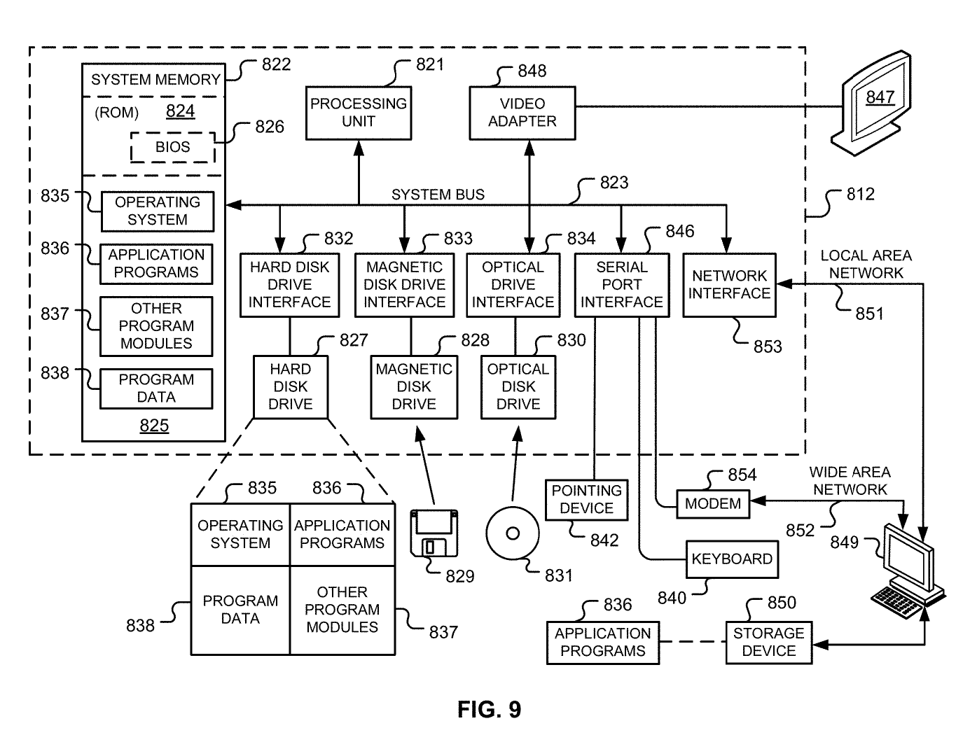

The cloud computing system 32 may include several servers, layers (or other elements), processes, and/or components, which may be chained or otherwise configured and may interact to perform tasks (such as obtaining data from an appropriate data store). In the embodiment illustrated in FIG. 8, the cloud computing system 32 includes at least one communications server 770, at least one application server 772, and a data store 810 (e.g., including the data storage 620 illustrated in FIG. 1). The servers 770 and 772 and the data store 810 may be implemented in various ways, such as by one or more hardware devices (e.g., like a computing device 812 illustrated in FIG. 9) and/or one or more virtual computer systems. Such virtual computer systems may be implemented by a programming module executed by one or more computer devices (e.g., like the computing device 812 illustrated in FIG. 9). By way of a non-limiting example, the servers 770, 772 and the data store 810 may be implemented by one or more computing devices (e.g., rack-mounted servers) arranged in one or more rack(s) inside a data center.

For ease of illustration, FIG. 8 includes only the single communications server 770 and the single application server 772. However, the cloud computing system 32 may include any number of the servers 770 and 772. The servers 770 and 772 may include any appropriate hardware, software, and firmware for integrating with the data store 810 as needed to execute aspects of one or more applications for the Master B/CMS unit 40, handling some or all of the data access and business logic for an application.

The data store 810 may include any device or combination of devices capable of storing, accessing, and retrieving data, which may include any combination and number of data servers, databases, data storage devices, and data storage media, in any standard, distributed, virtual or clustered environment. The data store 810 may include several separate data tables, databases, data documents, dynamic data storage schemes, and/or other data storage mechanisms and media for storing data related to the cloud computing system 32. The data store 810 is operable, through logic associated therewith, to receive instructions from the server 770 and/or the server 772. The data store 810 is operable, through logic associated therewith, to obtain, update, and/or otherwise process data in response to such instructions. Likewise, the data store 810 may be operable, through logic associated therewith, to send instructions and/or data to the server 770 and/or the server 772 for processing thereby.

The communications server 770 communicates over the network 30 with the Master B/CMS unit 40. The communications server 770 receives the data package 610 (see FIG. 1) from the Master B/CMS unit 40 and sends the software update 650 (see FIG. 1) to the Master B/CMS unit 40. The communications server 770 stores the data package 610 (see FIG. 1) in the data store 810 (e.g., within the data storage 620 illustrated in FIG. 1) and/or sends the data package 610 to the application server 772. The application server 772 receives the data package 610 (see FIG. 1) from the communications server 770 and/or retrieves the information received in the data package 610 from the data store 810. Optionally, the application server 772 may store the data package 610 (see FIG. 1) in the data store 810. The application server 772 stores the modules 630 and 640 or otherwise has access to the modules 630 and 640. The application server 772 executes the modules 630 and 640 and generates the software update 650 (see FIG. 1) based at least in part on the information received in the data package 610 (see FIG. 1). The application server 772 may store information (e.g., the software update 650) in the data store 810 (e.g., in the data storage 620). The communications server 770 receives the software update 650 (see FIG. 1) from the application server 772 and/or retrieves the software update 650 from the data store 810 and sends the software update 650 to the Master B/CMS unit 40. FIG. 9 is a diagram of hardware and an operating environment in conjunction with which implementations of the computing device(s) (e.g., the servers 770, 772 and the data store 810 illustrated in FIG. 8) of the cloud computing system 32 of FIGS. 1 and 8 may be practiced. The description of FIG. 9 is intended to provide a brief, general description of suitable computer hardware and a suitable computing environment in which implementations may be practiced.

The exemplary hardware and operating environment of FIG. 9 includes a general-purpose computing device in the form of the computing device 812. Each computing device used to implement the cloud computing system 32 (see FIGS. 1 and 8) may be substantially identical to the computing device 812. By way of non-limiting examples, the computing device 812 may be implemented as a rack-mounted server, a blade server, a laptop computer, a tablet computer, a web enabled television, a personal digital assistant, a game console, a smartphone, a mobile computing device, a cellular telephone, a desktop personal computer, and the like.

The computing device 812 includes a system memory 822, the processing unit 821, and a system bus 823 that operatively couples various system components, including the system memory 822, to the processing unit 821. There may be only one or there may be more than one processing unit 821, such that the processor of computing device 812 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), a specialized processor (e.g., implemented with programmable gate arrays (“PGA”) or application-specific integrated circuits (“ASICs”)), combinations thereof, and the like.

The system bus 823 may be any of several types of bus structures including a memory bus or memory controller, a peripheral bus, and a local bus using any of a variety of bus architectures. The system memory 822 may also be referred to as simply the memory, and includes read only memory (ROM) 824 and random access memory (RAM) 825. The system memory 822 may include the data storage 620 (see FIG. 1).

The computing device 812 may include a basic input/output system (BIOS) 826, containing the basic routines that help to transfer information between elements within the computing device 812, such as during start-up, is stored in ROM 824. Alternatively, the computing device 812 may operate as a BIOS-less system that includes one or more components (not shown) configured to provide substantially similar functionality.

The computing device 812 may include or be connected to a hard disk drive 827 for reading from and writing to a hard disk (not shown). Optionally, the computing device 812 may include or be connected to a magnetic disk drive 828 for reading from or writing to a removable magnetic disk 829, and an optical disk drive 830 for reading from or writing to a removable optical disk 831 such as a CD ROM, DVD, or other optical media. However, such components may be omitted.

When present, the hard disk drive 827, magnetic disk drive 828, and optical disk drive 830 are connected to the system bus 823 by a hard disk drive interface 832, a magnetic disk drive interface 833, and an optical disk drive interface 834, respectively. The drives and their associated computer-readable media provide nonvolatile storage of computer-readable instructions, data structures, program modules, and other data for the computing device 812. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 827 and other forms of computer-readable media (e.g., the removable magnetic disk 829, the removable optical disk 831, flash memory cards, SSD, USB drives, and the like) accessible by the processing unit 821 may be considered components of the system memory 822.

A number of program modules may be stored on the hard disk drive 827, the optional magnetic disk 829, the optional optical disk 831, the ROM 824, or the RAM 825, including an operating system 835, one or more application programs 836, other program modules 837, and program data 838. The operating system 835 may implement a wide variety of operating environments.

As explained above, the system memory 822 may include a variety of memory and storage media. Optionally, a portion of the system memory 822 may reside in a variety of locations, such as local to the computing device 812 or on a different computing device (such as a computing device 849 connected to the network 30 illustrated in FIGS. 1 and 8) that is remote from the computing device 812. For example, the system memory 822 includes a storage-area network (“SAN”) familiar to those of ordinary skill in the art. Similarly, any necessary files for performing the functions attributed to the computing device(s) of the cloud computing system 32 (see FIGS. 1 and 8) may be stored locally and/or remotely, as appropriate.

Although the cloud computing system 32 (see FIGS. 1 and 8) likely operates without the operator interacting directly with the computing device 812, optionally, input devices (such as a keyboard 840 and pointing device 842) may be connected to the computing device 812 so that a user may enter commands and information into the computing device 812. Other input devices (not shown) may include a microphone, joystick, game pad, satellite dish, scanner, touch sensitive devices (e.g., a stylus or touch pad), video camera, depth camera, or the like. These and other input devices may be connected to the processing unit 821 through an optional serial port interface 846 that is coupled to the system bus 823, but may be connected by other interfaces, such as a parallel port, game port, a universal serial bus (USB), or a wireless interface (e.g., a Bluetooth interface). Optionally, a monitor 847 or other type of display device may be connected to the system bus 823 via an optional interface, such as a video adapter 848. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface, which as described above, is optional and may be unnecessary.

The computing device 812 operates in a networked environment using logical connections to one or more other computers, such as the computing device 849. These logical connections are achieved by a communication device coupled to or a part of the computing device 812 (as the local computer). Implementations are not limited to a particular type of communications device. The computing device 849 may be another computer, a server, a router, a network PC, a client, a memory storage device, a peer device or other common network node, and typically includes many or all of the elements described above relative to the computing device 812. The computing device 849 may be connected to a memory storage device 850. The logical connections depicted in FIG. 9 include the network 30, which may be implemented by a local-area network (LAN) 851 and/or a wide-area network (WAN) 852. Such networking environments are commonplace in offices, enterprise-wide computer networks, intranets and the Internet. The network 30 (see FIGS. 1 and 8) may include an intranet, the Internet, a cellular network, a local area network, a satellite network or any other such network and/or combination thereof. By way of additional non-limiting examples, the network 30 (see FIGS. 1 and 8) may include a virtual private network, an extranet, a public switched telephone network, an infrared network, a wireless network, and the like. Components used to implement the network 30 (see FIGS. 1 and 8) may depend at least in part upon the type of network and/or environment selected. Many protocols and components for communicating via such a network are well known and will not be discussed herein in detail. Communication over the network 30 can be enabled by wired or wireless connections and combinations thereof.

The network 30 may support communications using one or more of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. In some embodiments, connection-oriented protocols may be used to communicate between network endpoints. Connection-oriented protocols (sometimes called connection-based protocols) are capable of transmitting data in an ordered stream. Connection-oriented protocols can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

Those of ordinary skill in the art will appreciate that a LAN may be connected to a WAN via a modem using a carrier signal over a telephone network, cable network, cellular network, or power lines. Such a modem may optionally be connected to the computing device 812 by an optional network interface (e.g., a serial or other type of port). Further, many laptop computers may connect to a network via a cellular data modem.

When used in a LAN-networking environment, the computing device 812 may be connected to the local area network 851 through a network interface or adapter 853, which is one type of communications device. When used in a WAN-networking environment, the computing device 812 typically includes a modem 854, a type of communications device, or any other type of communications device for establishing communications over the wide area network 852, such as the Internet. The modem 854, which may be internal or external, is connected to the system bus 823 (e.g., via the optional serial port interface 846). In a networked environment, program modules depicted relative to the personal computing device 812, or portions thereof, may be stored in the computing device 849 and/or the remote memory storage device 850. It is appreciated that the network connections shown are exemplary and other means of and communications devices for establishing a communications link between the computers may be used.

The computing device 812 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 822 stores computer executable instructions (e.g., the modules 630 and 640 illustrated in FIG. 1) that when executed by one or more processors (e.g., the processing unit 821) cause the one or more processors to perform all or portions of one or more of the processes or methods described above. Such instructions may be stored on one or more non-transitory computer-readable media. By way of non-limiting examples, the computer-executable instructions (e.g., stored in program modules, such as the modules 630 and 640 illustrated in FIG. 1) may include routines, programs, objects, components, data structures, etc., that perform particular tasks or implement particular data structures.

Storage media and computer readable media for containing computer executable instructions may include any appropriate media known or used in the art, including storage media and communication media, such as, but not limited to, volatile and non-volatile, removable and non-removable media implemented in any method or technology for storage and/or transmission of information (such as computer readable instructions, data structures, program modules or other data) Non-limiting examples of such computer readable media include RAM, ROM, Electrically Erasable Programmable Read-Only Memory (“EEPROM”), flash memory or other memory technology, Compact Disc Read-Only Memory (“CD-ROM”), digital versatile disk (“DVD”) or other optical storage medium, magnetic cassettes, magnetic tape, magnetic disk storage or other magnetic storage devices or any other medium that may be used to store the desired information and which can be accessed by the processing unit 821.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A battery management system comprising:
a plurality of sheets each comprising a plurality of energy storage devices and an active balancing circuit, the active balancing circuit being configured to identify one of the plurality of energy storage devices having a lowest voltage as a lowest voltage device, and use power received from a portion of the plurality of energy storage devices to charge the lowest voltage device; and
a buffer circuit connected to the plurality of sheets and operable to transfer power; and
a master management system connected to the buffer circuit and the active balancing circuit of each of the plurality of sheets, the master management system receiving information from the active balancing circuit of each of the plurality of sheets and using the information to identify a second portion of the plurality of sheets, the master management system being configured to instruct the buffer circuit to receive first power from a first portion of the plurality of sheets, and send at least a portion of the first power as second power to the second portion of the plurality of sheets.

2. The battery management system of claim 1, wherein each of the plurality of energy storage devices comprises a plurality of cells connected together in parallel or series.

3. The battery management system of claim 2, wherein each of the plurality of cells comprises at least one battery or at least one capacitor.

4. The battery management system of claim 1, wherein the buffer circuit comprises a capacitor pack with a plurality of capacitors connected together in series, the capacitor pack being configured to store the first power in the plurality of capacitors.

5. The battery management system of claim 1, wherein the buffer circuit comprises at least one bi-directional direct current to direct current (“DC-DC”) converter.

6. The battery management system of claim 5, wherein the buffer circuit comprises a storage device configured to store the first power,
the master management system is connected to the at least one bi-directional DC-DC converter and configured to instruct the at least one bi-directional DC-DC converter to receive the first power from the first portion of the plurality of sheets, send the first power to the storage device for storage, receive the second power from the storage device, and send the second power to the second portion of the plurality of sheets.

7. The battery management system of claim 1, wherein the buffer circuit comprises:
a storage device configured to store the first power; and
multiple single-direction direct current to direct current (“DC-DC”) converters, a first portion of the multiple single-direction DC-DC converters being configured to receive the second power from the storage device, and send the second power to the second portion of the plurality of sheets, a second portion of the multiple single-direction DC-DC converters being configured to receive the first power from the first portion of the plurality of sheets and send the first power to the storage device for storage, the second portion being different from the first portion.

8. The battery management system of claim 7, wherein the master management system is connected to the first portion of the multiple single-direction DC-DC converters, the master management system being configured instruct the first portion of the multiple single-direction DC-DC converters to send the second power to the second portion of the plurality of sheets.

9. The battery management system of claim 8, wherein the master management system is connected to the second portion of the multiple single-direction DC-DC converters and configured instruct the second portion of the multiple single-direction DC-DC converters to receive the first power from the first portion of the plurality of sheets.

10. The battery management system of claim 1, wherein the active balancing circuit comprises a DC-DC converter, a multiplexer, a microcontroller and instructions executable by the microcontroller, the instructions, when executed by the microcontroller, instructing the microcontroller to perform a method comprising:
identifying the lowest voltage device;
determining an average voltage of the plurality of energy storage devices;
determining whether the lowest voltage is within a predetermined range of the average voltage; and
when the microcontroller determines the lowest voltage is not within the predetermined range of the average voltage, instructing the DC-DC converter and the multiplexer to use the power received from the portion of the plurality of energy storage devices to charge the lowest voltage device.

11. A battery management system configured to communicate with an external computing system, the battery management system comprising:
a sheet comprising a plurality of energy storage devices, at least one communication hardware module, and a processor, the plurality of energy storage devices being connected together in series, the processor being connected to the at least one communication hardware module and each of the plurality of energy storage devices, the processor being configured to determine at least one parameter for the plurality of energy storage devices, and send the at least one parameter to the at least one communication hardware module; and
a master management system operable to communicate with both the at least one communication hardware module and the external computing system, the master management system being configured to receive the at least one parameter from the at least one communication hardware module and send a data package comprising the at least one parameter to the external computing system.

12. The battery management system of claim 11, wherein the master management system is configured to receive a software update from the external computing system, and send the software update to the at least one communication hardware module, the processor being configured to receive the software update from the at least one communication hardware module.

13. The battery management system of claim 11, wherein each of the plurality of energy storage devices comprises a plurality of cells connected together in parallel.

14. The battery management system of claim 13, wherein each of the plurality of cells comprises at least one battery or at least one capacitor.

15. The battery management system of claim 11, further comprising:
a plurality of sheets comprising the sheet; and
a buffer circuit connected to the sheet and operable to store power, the master management system being configured to identify a second portion of the plurality of sheets, the master management system being configured to instruct the buffer circuit to receive first power from a first portion of the plurality of sheets, store the first power, and instruct the buffer circuit to send at least a portion of the stored power as second power to the second portion of the plurality of sheets.

16. The battery management system of claim 15, wherein the buffer circuit comprises a capacitor pack with a plurality of capacitors connected together in series, the capacitor pack being configured to store the first power in the plurality of capacitors.

17. The battery management system of claim 15, wherein the buffer circuit comprises at least one bi-directional direct current to direct current (“DC-DC”) converter,
the master management system is connected to the at least one bi-directional DC-DC converter, and
the master management system is configured instruct the at least one bi-directional DC-DC converter to either send the second power to the second portion of the plurality of sheets or receive the first power from the first portion of the plurality of sheets.

18. The battery management system of claim 15, wherein the buffer circuit comprises multiple single-direction direct current to direct current (“DC-DC”) converters,
the master management system is connected to the multiple single-direction DC-DC converters,
the master management system is configured instruct a first portion of the multiple single-direction DC-DC converters to send the second power to the second portion of the plurality of sheets,
the master management system is configured instruct a second portion of the multiple single-direction DC-DC converters to receive the first power from the first portion of the plurality of sheets, and
the second portion of the multiple single-direction DC-DC converters is different from the first portion of the multiple single-direction DC-DC converters.

19. The battery management system of claim 11, wherein the sheet comprises a DC-DC converter and a multiplexer, and
the processor is configured to instruct the DC-DC converter and the multiplexer to use power received from a portion of the plurality of energy storage devices to charge one of the plurality of energy storage devices having a lowest voltage.

20. An electric vehicle comprising:
a battery management system comprising a master management system and a battery pack with a plurality of sheets and a buffer circuit, the plurality of sheets each comprising an energy storage device, the buffer circuit being connected to the plurality of sheets, the master management system receiving information from the plurality of sheets and using the information to identify a second portion of the plurality of sheets, the master management system being configured to instruct the buffer circuit to receive first power from a first portion of the plurality of sheets, and send at least a portion of the first power as second power to the second portion of the plurality of sheets; and
an electric motor connected to the battery pack and configured to receive third power from the battery pack.

21. The electric vehicle of claim 20, wherein the energy storage devices comprises a plurality of cells connected together in parallel or series, and
each of the plurality of cells comprises at least one battery or at least one capacitor.

22. The electric vehicle of claim 20, wherein the buffer circuit comprises a capacitor pack with a plurality of capacitors connected together in series, the capacitor pack being configured to store the first power in the plurality of capacitors.

23. The electric vehicle of claim 20, wherein the buffer circuit comprises at least one bi-directional direct current to direct current (“DC-DC”) converter,
the master management system is connected to the at least one bi-directional DC-DC converter, and
the master management system is configured instruct the at least one bi-directional DC-DC converter to either send the second power to the second portion of the plurality of sheets or receive the first power from the first portion of the plurality of sheets.

24. The electric vehicle of claim 20, wherein the buffer circuit comprises multiple single-direction direct current to direct current (“DC-DC”) converters,
the master management system is connected to the multiple single-direction DC-DC converters,
the master management system is configured instruct a first portion of the multiple single-direction DC-DC converters to send the second power to the second portion of the plurality of sheets,
the master management system is configured instruct a second portion of the multiple single-direction DC-DC converters to receive the first power from the first portion of the plurality of sheets, and
the second portion of the multiple single-direction DC-DC converters is different from the first portion of the multiple single-direction DC-DC converters.
